(19) United States
(12) Patent Application Publication
(10) Pub. No.: US 2024/0427988 A1
(43) Pub. Date: Dec. 26, 2024

(54) HARASSMENT INFORMATION PROVIDING APPARATUS, HARASSMENT INFORMATION PROVIDING METHOD, AND PROGRAM STORAGE MEDIUM

(71) Applicant: NEC Corporation, Tokyo (JP)

(72) Inventor: Ichiro JOJA, Tokyo (JP)

(73) Assignee: NEC Corporation, Tokyo (JP)

(21) Appl. No.: 18/738,183

(22) Filed: Jun. 10, 2024

(30) Foreign Application Priority Data
Jun. 26, 2023 (JP) 2023-104272

(51) Int. Cl. G06F 40/279; G10L 15/26

(52) U.S. Cl. CPC G06F 40/279; G10L 15/26

(57) ABSTRACT

A speech-to-text unit of a harassment information providing apparatus converts an utterance of a speaker into text using speech data of a conversation. A determination unit calculates a negative level and a positive level of the conversation by analyzing text data indicating the utterance converted into text, and determines the level of harassment of the conversation by using the negative level and the positive level. An output unit outputs harassment information including information indicating the level of harassment.

This application is based upon and claims the benefit of priority from Japanese Patent Application No. 2023-104272, filed on Jun. 26, 2023, the disclosure of which is incorporated herein in its entirety by reference.

### TECHNICAL FIELD

The present disclosure provides a technology for suppressing harassment.

### BACKGROUND ART

There is a growing awareness of suppression of harassment in a workplace. Reference 1 (JP 2020-9238 A) and Reference 2 (JP 2023-9563 A) disclose technologies related to detection of harassment using prohibited words for harassment detection and notification thereof to prevent harassment.

A main object of the present disclosure is to provide a technology capable of presenting understandable information leading to suppression of harassment to a person who has made an utterance that raises a concern about harassment in a conversation.

### SUMMARY

In order to achieve the above object, as one aspect of the present disclosure, a harassment information providing apparatus includes a memory configured to store instructions, and at least one processor configured to execute the instructions to convert an utterance of a speaker into text using speech data of a conversation, calculate a negative level and a positive level of the conversation by analyzing text data indicating the utterance converted into text, and determine the level of harassment of the conversation by using the calculated negative level and positive level, and output harassment information including information indicating the determined level of harassment.

As one aspect of the present disclosure, a harassment information providing method is executed by a computer, the harassment information providing method including converting an utterance of a speaker into text using speech data of a conversation, calculating a negative level and a positive level of the conversation by analyzing text data indicating the utterance converted into text, and determining the level of harassment of the conversation by using the calculated negative level and the positive level, and outputting harassment information including information indicating the determined level of harassment.

As one aspect of the present disclosure, a non-transitory computer readable medium stores a computer program for causing a computer to execute processing of converting an utterance of a speaker into text based on speech data of a conversation, calculating a negative level and a positive level of the conversation by analyzing text data indicating the utterance converted into text, and determining the level of harassment of the conversation by using the calculated negative level and the positive level, and outputting harassment information including information indicating the determined level of harassment.

### BRIEF DESCRIPTION OF THE DRAWINGS

Exemplary features and advantages of the present invention will become apparent from the following detailed description when taken with the accompanying drawings in which:

FIG. 1 is a diagram for describing a configuration example of a harassment information providing apparatus (information providing apparatus) according to the present disclosure;

FIG. 2 is a diagram illustrating an example of text data obtained by converting speech data into text by speech-to-text processing;

FIG. 3 is a diagram illustrating examples of a negative word;

FIG. 4 is a diagram illustrating examples of a positive word;

FIG. 5 is a diagram illustrating examples of the positive word;

FIG. 6 is a diagram illustrating an example of display in a case where harassment information is displayed on a display device;

FIG. 7 is a diagram illustrating another example of the display of the harassment information;

FIG. 8 is a diagram illustrating still another example of the display of the harassment information;

FIG. 9 is a flowchart for describing an operation example of the harassment information providing apparatus (information providing apparatus);

FIG. 10 is a diagram illustrating still another example of the display of the harassment information;

FIG. 11 is a diagram for describing another configuration example of the harassment information providing apparatus (information providing apparatus); and

FIG. 12 is a flowchart for describing another operation example of the harassment information providing apparatus (information providing apparatus).

### EXAMPLE EMBODIMENT

Hereinafter, example embodiments of the present disclosure will be described with reference to the drawings.

### First Example Embodiment

A harassment information providing system according to a first example embodiment of the present disclosure is a system for suppressing harassment in a workplace or the like, and focuses on conversation. The harassment information providing system has a function of determining the level of harassment of an utterance in a conversation and a function of outputting harassment information including the level of harassment. The harassment is so-called abuse, and is an act of inflicting physical and mental pain such as making a counterpart feel uncomfortable or giving a disadvantage, and there are a plurality of types of harassment. Examples of the type of the harassment include power harassment, sexual harassment, maternity harassment, and moral harassment. Here, the type of the harassment to be suppressed is not limited.

The harassment information output by the harassment information providing system according to the first example embodiment includes information indicating the level of harassment in a conversation. The harassment information is provided (output) to at least a person who is determined to have made an utterance equivalent to harassment. In the following description, an utterance that is equivalent to harassment or an utterance that raises a concern about harassment is also referred to as a harassment utterance, and a person who is determined to have made an utterance that is equivalent to harassment is also referred to as a harassment utterer.

The level of harassment included in the harassment information is determined (calculated) in consideration of a positive level in addition to a negative level related to a harassment utterance in a conversation. In other words, here, the present inventors have paid attention to the fact that the level of harassment does not necessarily increase as the number of negative utterances in a conversation (utterances leading to harassment (harassment utterances)) increases. The present inventors have considered that, as a factor thereof, a conversation may include a positive utterance (an utterance that reduces harassment), and inclusion of a positive utterance in a conversation reduces the level of harassment in a conversation. From this, the present inventors have considered that the certainty of the level of harassment can be further increased by using the positive level calculated from the number of positive utterances and the like in addition to the negative level as compared with a case where the level of harassment is determined only from the negative level calculated from the number of negative utterances and the like.

In the harassment information providing system according to the first example embodiment, not only the harassment utterer is notified of the fact that harassment has been detected by determination on the presence or absence of harassment but also the harassment information including information indicating the level of harassment in a conversation is output as described above. It is considered that in many cases, the harassment utterer does not realize that he or she has made an utterance equivalent to harassment. Furthermore, there is a tendency that the level of harassment gradually increases from a low level to a high level. In view of the above, the harassment information providing system according to the first example embodiment aims to cause the harassment utterer to notice his or her harassment utterance before the level of harassment becomes high by making a notification of (outputting) the harassment information to the harassment utterer in a state where the level of harassment is low. In addition, the harassment information providing system according to the first example embodiment aims to cause the harassment utterer to notice the harassment utterance with a sense of understanding by making a notification of the information indicating the level of harassment. In other words, there is a problem that, in a case where the level of harassment of the harassment utterance is low, the harassment utterer cannot obtain a feeling of understanding even when the harassment utterer is warned about harassment, which makes it difficult to achieve suppression of harassment. On the other hand, in the harassment information providing system according to the first example embodiment, the harassment utterer is notified of the information regarding the level of harassment, and thus, it is expected that information indicating that “Although the level is low, it is still a harassment utterance.” can be transmitted to the harassment utterer.

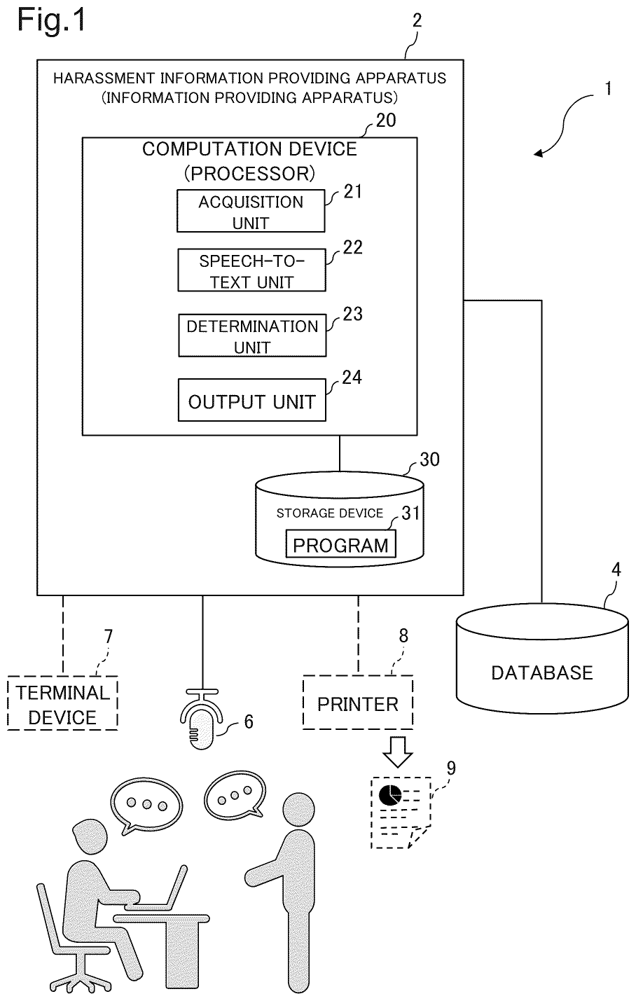

Hereinafter, a configuration of the harassment information providing system according to the first example embodiment will be described. As illustrated in FIG. 1, a harassment information providing system 1 according to the first example embodiment includes a harassment information providing apparatus (hereinafter, also simply referred to as an information providing apparatus) 2. The information providing apparatus 2 is connected to a microphone 6.

The microphone 6 has a function of collecting a speech of conversation, converting the speech into speech data that is an electric signal, and outputting the speech data. As described above, the harassment information providing system 1 according to the first example embodiment focuses on harassment in conversation. The conversation may be directly conducted in a face-to-face manner or may be conducted by using an information device (including a telephone) instead of a face-to-face manner like a call or an online meeting. Here, any case can be handled. For example, in a case of collecting a speech of a conversation conducted in a face-to-face manner, the microphone 6 is arranged in a place where an utterance of a conversation in a workplace or the like that is a harassment suppression target can be collected in the workplace or the like. In this case, the microphone 6 may be a single device or may be built in an information device such as a smartphone. In addition, in a case of collecting a speech of a conversation conducted not in a face-to-face manner but by using an information device, such as a call or an online meeting, a microphone provided in the information device functions as the microphone 6 used in the system.

The information providing apparatus 2 is a computer apparatus, and includes a computation device 20 and a storage device 30. The storage device 30 includes a storage medium that stores data and a computer program (hereinafter, also referred to as a program) 31. There are a plurality of types of storage devices such as a magnetic disk device and a semiconductor memory element, and there are a plurality of types of semiconductor memory elements such as a random access memory (RAM) and a read only memory (ROM). The information providing apparatus 2 includes a plurality of storage devices having different uses, but the type and number thereof are not limited here, and a description thereof will be omitted. In addition, the plurality of storage devices included in the information providing apparatus 2 are collectively referred to as the storage device 30 without distinction.

The computation device 20 includes a processor such as a central processing unit (CPU) or a graphics processing unit (GPU). The computation device 20 can have various functions based on the program 31 by reading and executing the program 31 stored in the storage device 30. Here, the computation device 20 includes an acquisition unit 21, a speech-to-text unit 22, a determination unit 23, and an output unit 24 as functional units related to provision of the harassment information.

The acquisition unit 21 acquires speech data of a conversation collected by the microphone 6. The following aspects are conceivable as aspects in which speech data of a conversation collected by the microphone 6 is provided to the information providing apparatus 2. As one aspect, for example, the microphone 6 or an information device including the microphone 6 is connected to the information providing apparatus 2, and speech data is provided (transmitted) from the microphone 6 or the information device to the information providing apparatus 2 in real time. Furthermore, as another aspect, in a case where the microphone 6 is built in an information device such as a smartphone and speech data of a conversation collected by the microphone 6 is recorded by a recording function of the information device, the recorded speech data is provided from the information device to the information providing apparatus 2. In the first example embodiment, the aspect in which speech data collected by the microphone 6 is provided to the information providing apparatus 2 is not limited.

The acquisition unit 21 acquires speech data of a conversation collected by the microphone 6 and provided to the information providing apparatus 2. Then, the acquisition unit 21 stores the acquired speech data in the storage device 30. In addition, in a case where the information providing apparatus 2 is connected to a database 4 which is a storage device, the acquisition unit 21 may store the acquired speech data in the database 4. As for the speech data stored in the storage device 30 or the database 4, for example, speech data from the start to the end of a conversation is one file (a unit of storage). Information regarding the start and end of the conversation is input to the information providing apparatus 2 by an operator of the information providing apparatus 2, for example. Further, a file of speech data stored in the storage device 30 or the database 4 is associated with file identification information for identifying the file of the speech data, time information indicating a date and time when the conversation is conducted, and the like. In a case where pieces of speech data are sequentially provided in real time from the microphone 6, for example, the pieces of speech data are sequentially temporarily stored and then collected into one file of the speech data as described above and stored in the storage device 30.

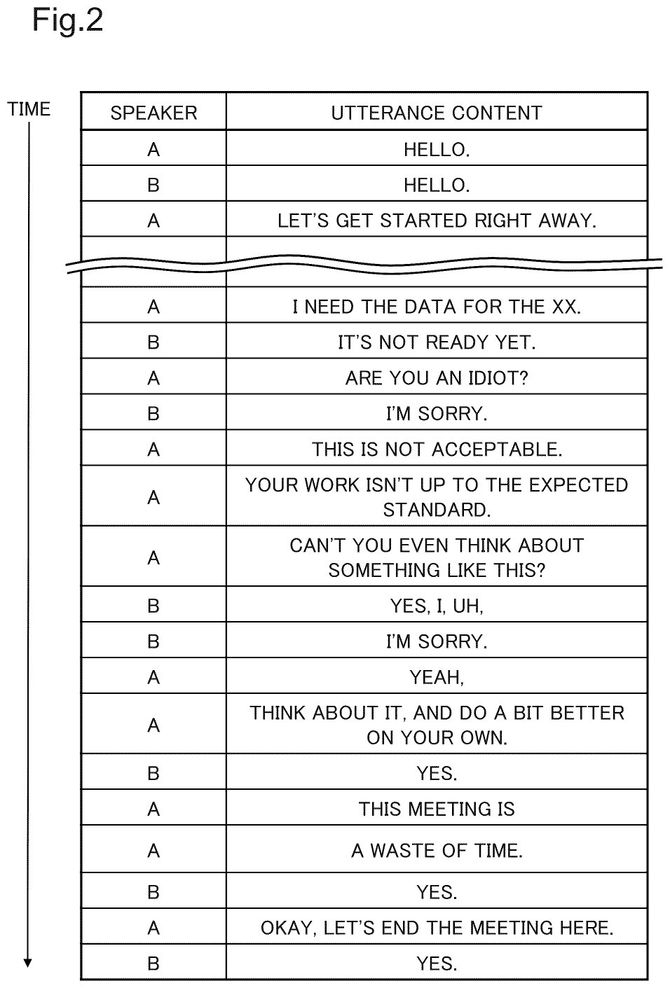

The speech-to-text unit 22 executes speech-to-text processing of converting an utterance of a speaker in a conversion into text based on speech data of the conversation acquired by the acquisition unit 21. Here, conversion into text means conversion of speech data into text data (character data). There are various methods for the speech-to-text processing of converting speech data into text data, and here, the method for the speech-to-text processing is not limited, and a description thereof will be omitted. However, the speech-to-text processing here includes not only processing of simply converting speech data into text data but also processing of discriminating utterances of a plurality of speakers in a conversation for each speaker. FIG. 2 illustrates an example of contents of a conversation converted into text by such speech-to-text processing. In the example of FIG. 2, contents of utterances are expressed by text in time series from the top, and speaker identification information indicating a speaker who has made an utterance is associated with a character string of the utterance.

The speech-to-text processing in the speech-to-text unit 22 may be executed after the conversation ends, or may be executed in real time while the conversation is being conducted. In a case where the speech-to-text processing is executed after the conversation ends, a file of speech data to be subjected to the speech-to-text processing is stored in the storage device 30 or the database 4. Therefore, the speech-to-text unit 22 reads the file of the speech data to be subjected to the speech-to-text processing from the storage device 30 or the database 4, and converts the read speech data into text data. Examples of a timing for executing such speech-to-text processing include a timing when a command from the operator is received and a timing when it is detected that a file of speech data is stored in the storage device 30 or the database 4.

In a case where speech data of a conversation is transmitted to the information providing apparatus 2 in real time, setting information for executing the speech-to-text processing in real time may be given to the information providing apparatus 2. In this case, the speech-to-text unit 22 sequentially converts pieces of transmitted speech data into text data. In this case, the text data converted by the speech-to-text processing is temporarily stored in association with the temporarily stored speech data that is original speech data subjected to the speech-to-text processing and is transmitted in real time.

When the speech-to-text processing of the conversation is completed, the speech-to-text unit 22 stores the file of the text data obtained by the speech-to-text processing in the storage device 30 or the database 4 so as to be associated with a file of the original speech data subjected to the speech-to-text processing.

The determination unit 23 determines the level of harassment of a conversation for each speaker of the conversation by using text data indicating a content of the conversation. The determination unit 23 uses not only the negative level of a conversation but also the positive level in a case of determining the level of harassment of the conversation. The reason is that, as described above, the present inventors have noticed that a conversation may include a positive utterance (an utterance that reduces harassment), and inclusion of a positive utterance in a conversation reduces the level of harassment in a conversation. Therefore, the present inventors have considered that the certainty of the level of harassment can be further increased by using the positive level (positive utterance) in addition to the negative level as compared with a case where the level of harassment is determined only by the negative level (negative utterance).

For this reason, the determination unit 23 first calculates the negative level and the positive level by analyzing text data indicating a content of a conversation. Then, the determination unit 23 determines the level of harassment of the conversation by using the detected negative level and positive level.

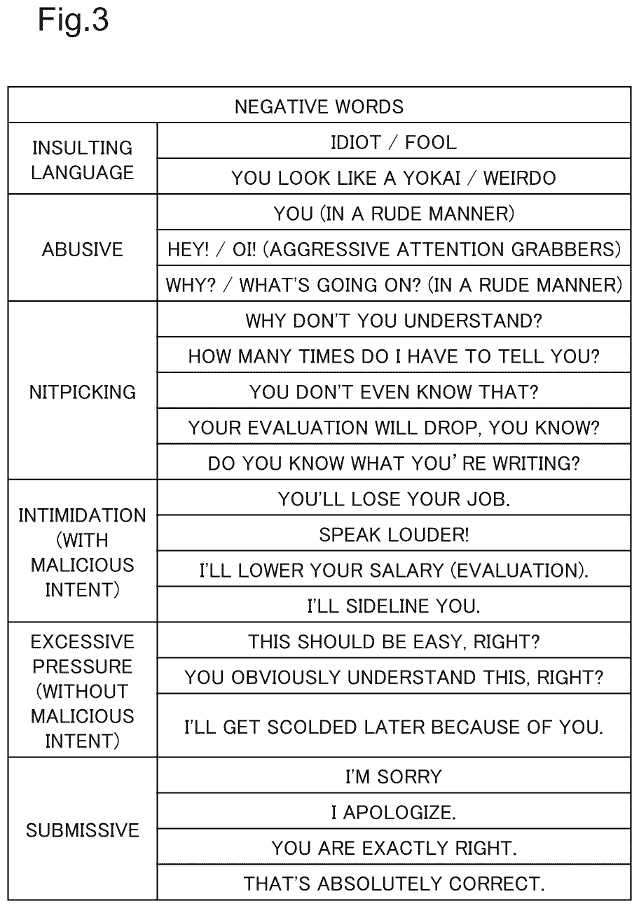

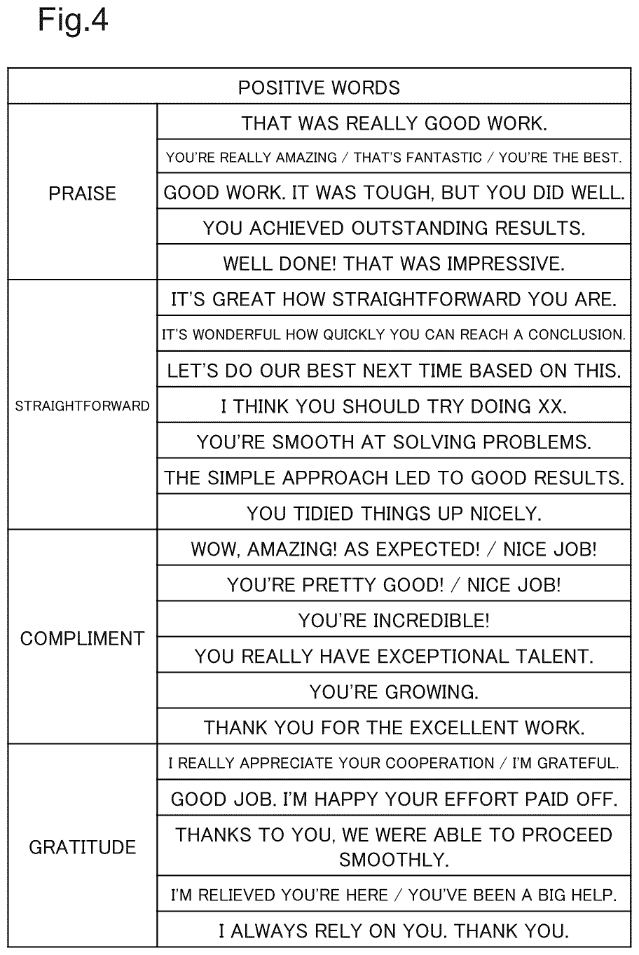

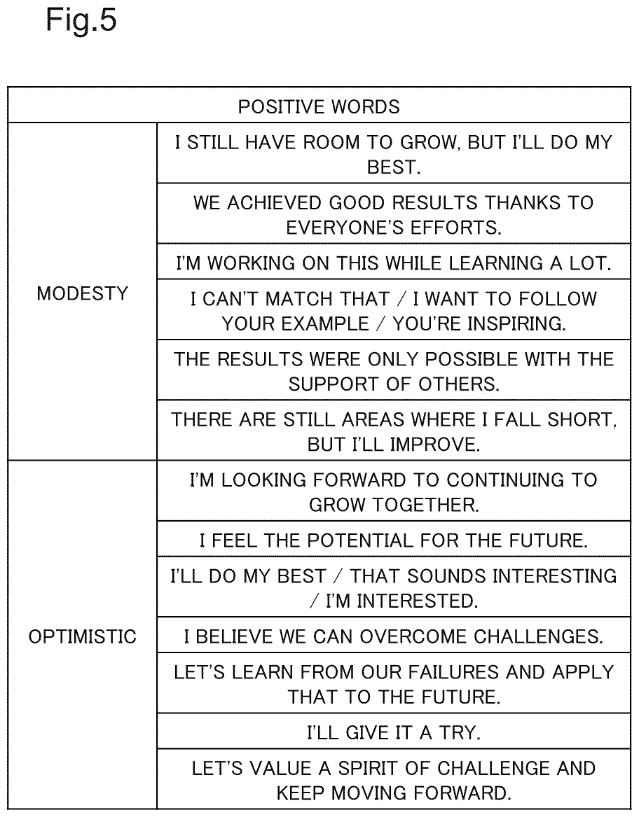

As a method of calculating each of the negative level and the positive level in a conversation, the following method can be exemplified. For example, data of negative words and positive words as illustrated in FIGS. 3 to 5 is stored in advance in the storage device 30 of the information providing apparatus 2. By referring to such data, negative words (negative utterances) and positive words (positive utterances) included in a conversation are extracted from text data of the conversation, and the negative words and the positive words are counted by the determination unit 23. Then, the negative level is calculated by multiplying a count value of the negative words by a negative coefficient. Furthermore, the positive level is calculated by multiplying a count value of the positive words by a positive coefficient. The negative coefficient and the positive coefficient change according to the length of the conversation for which the negative words and the positive words are counted. That is, since the length of the conversation for which the negative words and the positive words are counted varies, the length of the conversation is normalized by the negative coefficient or the positive coefficient. Furthermore, a magnitude relationship between the negative coefficient and the positive coefficient is set in consideration of a difference in magnitude between an influence of the negative utterance on people and an influence of the positive utterance on people. The difference in magnitude between the influence of the negative utterance on people and the influence of the positive utterance on people is obtained by, for example, experiments or simulations.

In a case where the determination unit 23 calculates the negative level and the positive level respectively after a conversation ends, the negative level and the positive level in one conversation (one file of speech data) from the start to the end of the conversation are calculated. Furthermore, in a case where speech data acquisition and the speech-to-text processing are executed in real time during a conversation, for example, negative words and positive words are counted in real time by the determination unit 23. Then, the negative level and the positive level in the conversation from the start of the conversation to a time point when processing of counting the negative words and the positive words is completed are calculated.

By the way, it is considered that a feeling in response to a word, particularly, a feeling in response to a positive word, varies depending on a situation and an individual. In this regard, as a method of calculating the negative level and the positive level, the following method considering utterances before and after the negative word and the positive word are uttered may be used. For example, it is assumed that 10 points are given as a standard value for one positive word. Here, in a case where it is determined that a positive influence of a certain positive word is lower than the standard due to the preceding and following utterances, a point given for the positive word is lowered by the degree of influence, for example, the point is 7 points. By doing so, the positive influence is quantified for each positive word. Furthermore, by adding points of positive words extracted from a conversation, the number of positive words in the conversation and the points obtained by quantifying the influences thereof are calculated. Point calculation is similarly performed for negative words. The negative level and the positive level may be calculated using the point for the positive word, the point for the negative word, and the negative coefficient and the positive coefficient as described above.

The determination unit 23 further calculates the level of harassment in a conversation by using the negative level and the positive level calculated as described above. An example of a method of calculating the level of harassment includes a method of calculating the level of harassment by subtracting a value of the positive level from a value of the negative level. The level of harassment may be represented by a numerical value obtained by such a calculation method, or may be represented by a rank (level) obtained by classifying harassment into a plurality of levels. How to express the level is appropriately set by a system designer in consideration of, for example, ease of understanding of the level of harassment.

The determination unit 23 determines (calculates), for each speaker of a conversation, the level of harassment by using the negative level and the positive level calculated as described above. In addition, the determination unit 23 stores information regarding the level of harassment for each speaker of the conversation thus determined in the storage device 30 or the database 4 in association with a file of associated speech data.

The output unit 24 outputs the harassment information. The harassment information is information including information indicating the level of harassment in a conversation. The harassment information is output at least to a person who has made the harassment utterance (harassment utterer). That is, the harassment information is information intended to cause the harassment utterer to notice his or her harassment utterance. Determination as to whether a speaker of a conversation is the harassment utterer is made using, for example, the level of harassment calculated for each speaker. For example, a threshold for determining whether a speaker is the harassment utterer by using the level of harassment is set in advance, and a speaker whose level of harassment is equal to or higher than the threshold is determined to be the harassment utterer.

The output unit 24 outputs, to at least the harassment utterer determined as described above, the harassment information including information indicating the level of harassment of the harassment utterer in the conversion. For example, an e-mail is used to output the harassment information. In a case where an e-mail is used, mail address information in which a speaker (speaker identification information) of a conversation and e-mail address information of the speaker are associated with each other is stored in the storage device 30 in advance. The output unit 24 extracts an e-mail address of the harassment utterer from the e-mail address information by using the speaker identification information associated to the harassment utterer, and outputs the harassment information to the harassment utterer by an e-mail using the address. The e-mail may include the harassment information itself, the harassment information may be attached to the e-mail, or the e-mail may include link information indicating a storage location in, for example, the database 4 in which the harassment information is stored.

A timing at which the output unit 24 outputs the harassment information is, for example, a timing set by a system setter after the level of harassment is determined in a case where the level of harassment in a conversation is determined after the conversation ends. Furthermore, in a case where the level of harassment is determined (calculated) in real time during a conversation, it is possible to output the harassment information during the conversation. However, in a case where a conversation time from the start of a conversation is short, there is a concern that harassment level information with a low reliability is output. In this regard, for example, in a case where an output condition for output of the harassment information in the middle of a conversation is determined in advance, and the harassment information is output during the conversation when the output condition is satisfied, such an output timing is another example of the timing at which the output unit 24 outputs the harassment information.

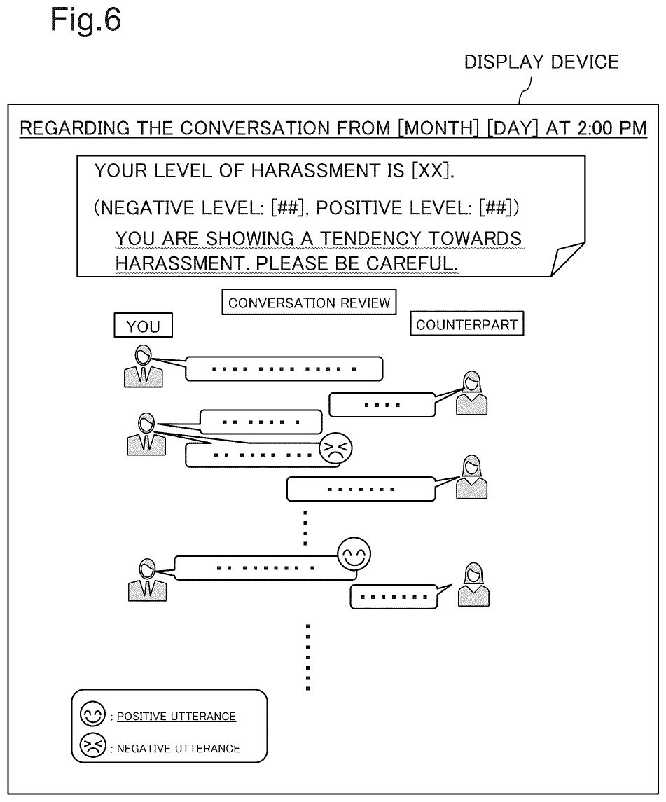

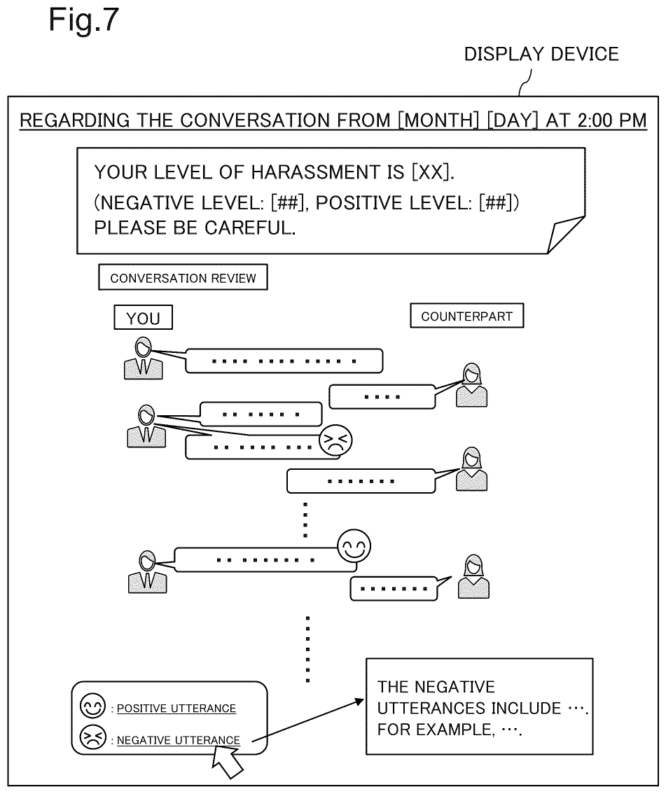

The harassment information output by the output unit 24 is displayed on, for example, a display device (not illustrated) of a terminal device 7 operated by the harassment utterer. FIG. 6 illustrates an example of display of the harassment information. In the example illustrated in FIG. 6, the level of harassment of the harassment utterer in a conversion that has caused the output of the harassment information is displayed together with the negative level and the positive level. Furthermore, in the example of FIG. 6, text data of the conversation that has caused the output of the harassment information is also displayed. Furthermore, in the example of FIG. 6, an indicator (a mark in the example of FIG. 6) for clarifying each of an utterance including a negative word and an utterance including a positive word is displayed. Furthermore, as illustrated in FIG. 7, a description of terms such as the positive utterance and the negative utterance may be popped up on a display screen displaying the harassment information. In a case where the display as illustrated in FIGS. 6 and 7 is made on the display device by a display control operation of the terminal device 7, the harassment information includes the following information in addition to information regarding the level of harassment. That is, the harassment information includes information regarding the level of harassment, the negative level, and the positive level, text data for each speaker of the conversation, and information specifying the negative word and the positive word included in the text data. Furthermore, the harassment information may include, for example, address information (link information) for connecting to a web page in which the description of the terms is indicated.

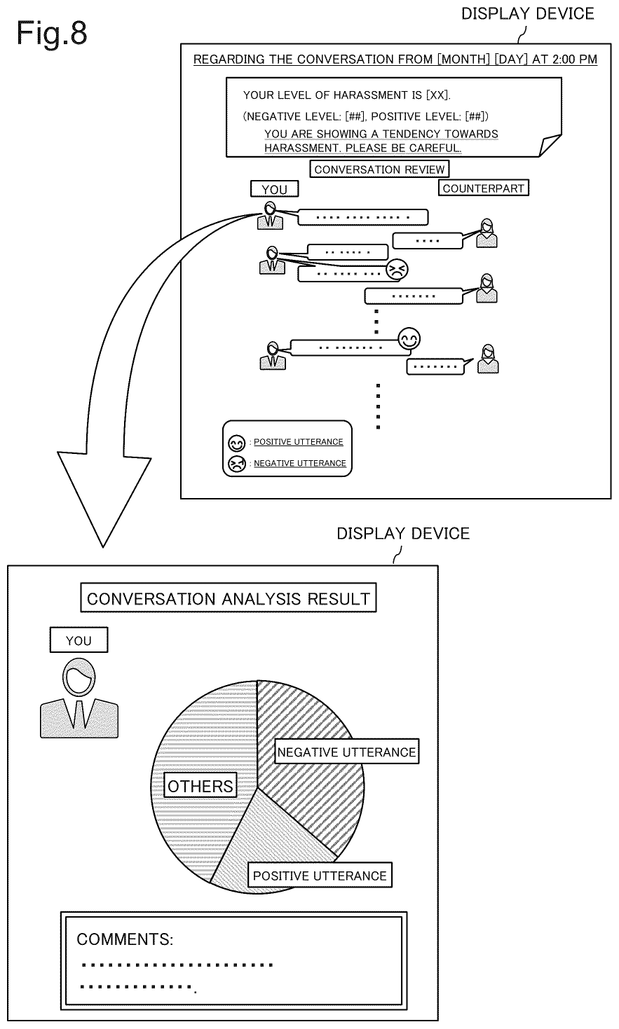

Furthermore, information indicating a conversation analysis result may be associated with the harassment information. In this case, for example, display control for transitioning from the display screen of the harassment information as illustrated in FIG. 6 to a screen displaying the conversation analysis result as illustrated in FIG. 8 may be performed. In the example of FIG. 8, utterances of the harassment utterer in the conversation are classified into the positive utterance, the negative utterance, and other utterances (others), and a ratio of the utterances in the conversation is displayed. Furthermore, the information regarding the conversation analysis result may include comment information indicating what should be noted in the conversation, and in this case, such information (comment) may also be displayed.

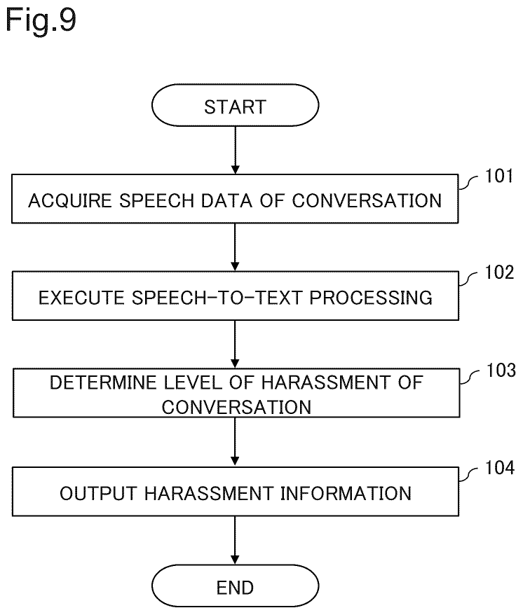

The harassment information providing system 1 according to the first example embodiment is configured as described above. Hereinafter, an example of an operation in the information providing apparatus 2 according to the first example embodiment will be described with reference to FIG. 9. FIG. 9 is a flowchart for describing an example of the operation in the information providing apparatus 2.

For example, the acquisition unit 21 first acquires speech data of a conversation collected by the microphone 6 for a conversation that is a harassment checking target (step 101). As a result, the speech-to-text unit 22 executes the speech-to-text processing of converting an utterance in the conversation into text based the acquired speech data (step 102).

Then, when the utterance in the conversation is converted into text data by the speech-to-text processing, the determination unit 23 analyzes the text data and calculates the positive level and the negative level. Furthermore, the determination unit 23 calculates the level of harassment by using the calculated negative level and positive level (step 103).

Thereafter, the output unit 24 outputs the harassment information including the level of harassment (step 104). For example, the harassment information is output at least to the harassment utterer, thereby causing the harassment utterer to notice that the harassment utterer has made an utterance that raises a concern about harassment.

The information providing apparatus 2 according to the first example embodiment included in the harassment information providing system 1 has the above-described configuration. That is, the information providing apparatus 2 is configured to determine the level of harassment in a conversation in consideration of not only a negative utterance that raises a concern about harassment but also a positive utterance. As a result, the information providing apparatus 2 can increase the certainty of a harassment level determination result as compared with a case where the level of harassment in a conversation is determined (calculated) using only a negative utterance, and can increase the reliability of the determination (calculation) of the level of harassment. In other words, the information providing apparatus 2 can present understandable information leading to suppression of harassment to a person who has made an utterance that raises a concern about harassment (the harassment utterer) in a conversation.

In addition, the information providing apparatus 2 not only outputs the fact that harassment has been detected by determination on the presence or absence of harassment, but also outputs the harassment information including the information indicating the level of harassment. Therefore, the information providing apparatus 2 is expected to be able to cause the harassment utterer to notice a harassment utterance without giving a discomfort feeling by outputting the harassment information including information indicating the level of harassment even when the level of harassment is low. Furthermore, if it is possible to cause the harassment utterer to notice a harassment utterance at a stage where the level of harassment is low as described above, it is considered that harassment can be suppressed before the level of harassment of the harassment utterer increases. That is, the information providing apparatus 2 can suppress the spread of the damage of harassment.

In the example described above, the terminal device 7 is taken as an example of an output destination for the output unit 24. However, for example, the output destination may be a printer 8 as illustrated by a dotted line in FIG. 1, or a paper medium 9 on which the harassment information is printed by the printer 8 may be provided to the harassment utterer.

Furthermore, in the example described above, the harassment information is output to the harassment utterer, but the harassment information may be output to all speakers in a conversation. Furthermore, in a case of a workplace, the harassment information may also be output to a boss of the harassment utterer. As described above, the output destination of the harassment information may be appropriately set in consideration of prevention of harassment.

### Second Example Embodiment

Hereinafter, a second example embodiment of the present disclosure will be described. In a description of the second example embodiment, the same reference numerals are given to portions with the same names as those of the constituent portions of the harassment information providing system according to the first example embodiment, and an overlapping description of the common portions will be omitted.

In the second example embodiment, a determination unit 23 in an information providing apparatus (a harassment information providing apparatus) 2 calculates each of a negative level and a positive level by using the following information in addition to information regarding the number of negative words and the number of positive words in a conversation as described in the first example embodiment.

That is, even in a case where the same negative word is uttered, the negative level felt by a recipient varies depending on the voice volume of the utterance, the voice tone such as harshness, a relationship (for example, a relationship between a boss and a subordinate, a relationship between colleagues, or a relationship between a salesclerk and a customer) between speakers of a conversation, and the like. Similarly, even in a case where the same positive word is uttered, the positive level felt by a recipient varies depending on the voice tone of the utterance, a relationship between speakers of a conversation, and the like. In this regard, in the second example embodiment, the negative level calculated from the number of negative words and the positive level calculated from the number of positive words are corrected by the determination unit 23 using the following information. The determination unit 23 determines the corrected negative level and positive level as the negative level and the positive level, respectively.

For example, as described above, there is a difference in feeling of a recipient (a person who has received the utterance) for an utterance from a conversation partner, depending on the voice tone of the utterance, a relationship between the speakers of the conversation, and the like. For this reason, it is conceivable to correct the negative level and the positive level by using information regarding the voice tone of an utterance that can be acquired from speech data and information regarding a relationship between speakers of a conversation. In this case, for example, relational data between an element of an utterance whose value changes, such as a voice volume or a speaking speed, and correction amounts for correcting the negative level and the positive level according to a change amount of the value of the element is obtained in advance by experiments or simulations and stored in a storage device 30 or the like. In addition, relational data between a relationship between speakers of a conversation and correction amounts of the negative level and the positive level is also obtained in advance by experiments or simulations and stored in the storage device 30 or the like. The determination unit 23 corrects the negative level and the positive level in a conversation for each speaker by using such relational data, information regarding values of the elements such as the voice volume and speaking speed of the speaker acquired (detected) from speech data of the conversation, and information indicating a relationship between the speakers. The information indicating the relationship between the speakers is input to the information providing apparatus 2 by, for example, an operator of the information providing apparatus 2. Furthermore, the relationship between the speakers is not limited to the above-described example, and examples of the relationship include a relationship based on the length of acquaintance, a relationship based on age difference, a relationship between a regular employee and a contract employee, and a relationship based on the same sex.

In addition, it is considered that the difference in feeling of a recipient for an utterance from a conversation partner is expressed by the magnitude of a change in emotion of the speaker when the speaker receives the utterance. For this reason, for example, it is conceivable to correct the negative level and the positive level by using information regarding the magnitude of the change in emotion of the speaker during the conversation. For example, the information regarding the magnitude of the change in emotion of the speaker during the conversation is acquired, and the determination unit 23 corrects the negative level and the positive level according to a difference between the acquired magnitude of the change in emotion and a predetermined reference magnitude of the change. As an example of a method of acquiring the information regarding the magnitude of the change in emotion of the speaker, the information is acquired from a change in expression in a face image obtained by imaging the face of the speaker. In addition, as another method of acquiring the information regarding the magnitude of the change in emotion of the speaker, for example, the information is acquired by a change in heart rate obtained from a change in color of the skin acquired from a captured image obtained by imaging the face or the like of the speaker. Furthermore, as another method, the information regarding the magnitude of the change in emotion may be acquired by a change in heart rate acquired by a wearable terminal worn by the speaker. As described above, there are a plurality of types of methods of acquiring the information regarding the magnitude of the change in emotion of the speaker. Here, the information regarding the magnitude of the change in emotion of the speaker acquired by any one of such methods may be used, or pieces of information regarding the magnitude of the change in emotion acquired by a plurality of acquisition methods may be used. In a case where a plurality of pieces of information regarding the magnitude of the change in emotion are used, for example, statistical processing of calculating an average value of the plurality of pieces of information and using the calculated value is executed.

Furthermore, it is considered that there is a difference in feeling of a recipient for an utterance from a conversation partner depending on the appearance of the conversation partner such as clothes or hairstyle, or a gesture of the conversation partner. For this reason, it is conceivable to correct the negative level and the positive level by using information regarding the appearance such as the clothes or hairstyle of the conversation partner or the gesture of the conversation partner. In this case, for example, information regarding the appearances and behaviors of the speakers is acquired from captured images of the speakers, and the determination unit 23 corrects the negative level and the positive level by using the acquired information and predetermined correction data.

Furthermore, it is considered that there is a difference in feeling of a recipient for an utterance from a conversation partner depending on the age, nationality, gender, personality, and the like of the speaker (recipient). For this reason, it is also conceivable to correct the negative level and the positive level by using attribute information such as the age, nationality, sex, and personality of the speaker in the conversation. In this case, for example, the determination unit 23 corrects the negative level and the positive level of the speakers by using the attribute information of the speakers input to the information providing apparatus 2 and the correction data given in advance.

As described above, there are a plurality of types of information used to correct the negative level and the positive level of the speakers. Here, the negative level and the positive level may be corrected by the determination unit 23 using any one type of information, or the negative level and the positive level may be corrected by the determination unit 23 using a plurality of types of information.

In the second example embodiment, the determination unit 23 determines the corrected negative level and positive level as the negative level and the positive level, respectively, as described above. The determination unit 23 determines (calculates) the level of harassment by using the determined negative level and positive level.

The information providing apparatus 2 according to the second example embodiment is similar to the information providing apparatus 2 according to the first example embodiment in a configuration other than the configuration related to the correction in the determination unit 23 described above.

Since the information providing apparatus 2 according to the second example embodiment has the same configuration as that of the first example embodiment, the same effects as those of the first example embodiment can be obtained. In addition to the configuration of the first example embodiment, the information providing apparatus 2 according to the second example embodiment has a configuration for correcting the negative level and the positive level calculated using the number of each of negative words and positive words included in a conversation. The correction is correction of the negative level and the positive level in consideration of the fact that a feeling of a recipient for an utterance varies depending on a situation of a conversation, a relationship between the speakers, and the like. The information providing apparatus 2 can increase the certainty of the level of harassment by determining (calculating) the level of harassment using the corrected negative level and positive level subjected to such correction. That is, the information providing apparatus 2 can increase the reliability of information regarding the level of harassment included in the harassment information.

### Third Example Embodiment

Hereinafter, a third example embodiment of the present disclosure will be described. In a description of the third example embodiment, the same reference numerals are given to portions with the same names as those of the constituent portions included in the harassment information providing system 1 according to the first or second example embodiment, and an overlapping description of the common portions will be omitted.

In the third example embodiment, an information providing apparatus 2 included in a harassment information providing system 1 has a configuration for determining the level of harassment in consideration of the degree of tolerance (sensitivity) of each speaker (recipient) to a harassment utterance in addition to the configuration of the first or second example embodiment. In other words, as described above, external factors such as a situation of a conversation and a relationship between speakers can be considered as factors causing a difference in feeling of a recipient for an utterance in a conversation. Furthermore, an internal factor of a speaker, such as tolerance (sensitivity) of each speaker to a harassment utterance, is also considered as the factor.

Therefore, in the third example embodiment, a determination unit 23 determines the level of harassment in consideration of such a degree of tolerance (sensitivity) of each speaker (recipient) to a harassment utterance. For example, the information providing apparatus 2 acquires information indicating the degree of tolerance (sensitivity) of each speaker to a harassment utterance (also referred to as “harassment tolerance information”). Then, the determination unit 23 corrects the level of harassment calculated using a negative level and a positive level by using the harassment resistance information and correction data, and determines the corrected level of harassment as the level of harassment. The correction data here is relational data between the degree of tolerance (sensitivity) to a harassment utterance and a correction amount of the level of harassment.

Examples of a method of acquiring the harassment resistance information include the following methods. For example, a questionnaire is conducted to investigate the degree of tolerance (sensitivity) to a harassment utterance for persons who can be speakers in a conversation that is a harassment checking target, and the degree of tolerance (sensitivity) of each speaker (recipient) to a harassment utterance is investigated by using the questionnaire answers. When the investigation result is input as the harassment resistance information, the information providing apparatus 2 acquires the harassment resistance information.

Furthermore, it is also conceivable to acquire the following types of harassment resistance information. For example, the information providing apparatus 2 acquires speech data of a conversation in real time, and receives an input of information indicating that an utterance is perceived as a harassment utterance from a speaker of the conversation. After data in which the information thus received and the speech data of the conversation are associated with each other is accumulated, the information providing apparatus 2 analyzes the data to calculate the degree of tolerance (sensitivity) to a harassment utterance for each speaker, thereby generating and acquiring the harassment resistance information. Instead of receiving the input of the information indicating that an utterance is perceived as a harassment utterance from the speaker of the conversation, for example, a sensor output of a heart rate sensor of a wearable terminal worn by the speaker of the conversation or a captured image of the face of the speaker of the conversation may be acquired. In this case, the information providing apparatus 2 detects a change in emotion of the speaker by using the information acquired as described above. Data in which the detection information and the speech data are associated with each other is accumulated. The information providing apparatus 2 analyzes the accumulated data to generate and acquire the harassment resistance information.

It is considered that maintenance is necessary for the above-described harassment resistance information. That is, it is considered that the degree of tolerance (sensitivity) of a person to a harassment utterance changes depending on a change in environment surrounding the person, a change in health condition, or the like. Therefore, the information providing apparatus 2 preferably acquires an updated version of harassment resistance information at a predetermined timing, for example.

A configuration of the information providing apparatus 2 according to the third example embodiment other than the configuration related to the above-described correction of the level of harassment is similar to that of the first or second example embodiment.

Since the information providing apparatus 2 according to the third example embodiment has the same configuration as that of the first or second example embodiment, the same effects as those of the first or second example embodiment can be obtained. Furthermore, the information providing apparatus 2 according to the third example embodiment has a configuration for correcting the level of harassment according to a tolerance (sensitivity) of a speaker (recipient) to a harassment utterance. As a result, the information providing apparatus 2 according to the third example embodiment can determine the level of harassment according to the degree of tolerance of a recipient who has received an utterance of a conversation to a harassment utterance. That is, the information providing apparatus 2 according to the third example embodiment can determine the level of harassment according to actual circumstances.

### Other Example Embodiments

The present disclosure is not limited to the first to third example embodiments, and various example embodiments can be adopted. For example, an information providing apparatus 2 may have a function of determining an output timing of harassment information in addition to the configurations of the first to third example embodiments. In other words, in a case where information for warning a person (a harassment utterer) who has made a harassment utterance is presented during a conversation including the harassment utterance, the warning may exhibit an effect of suppressing harassment, or conversely, the warning may harm the mood of the harassment utterer and has an adverse effect. Therefore, the information providing apparatus 2 monitors a state of the harassment utterer by using speech data or a captured image during the conversation including the harassment utterance. Then, an output unit 24 determines whether to output harassment information during the conversation or after the conversation by using the monitor information and a harassment information output criterion, outputs the harassment information according to the determination result. The harassment information output criterion is information indicating a criterion for determining whether to output the harassment information during the conversation or after the conversation. As the criterion, for example, a relationship between a state of an emotion of the speaker (harassment utterer) during the conversation and an effect of suppressing harassment by presenting the harassment information is obtained by experiments or simulations. The result is used for determination.

By providing such a function of determining the output timing of the harassment information, the information providing apparatus 2 can output the harassment information at a timing at which the effect of suppressing harassment by the harassment information can be easily obtained.

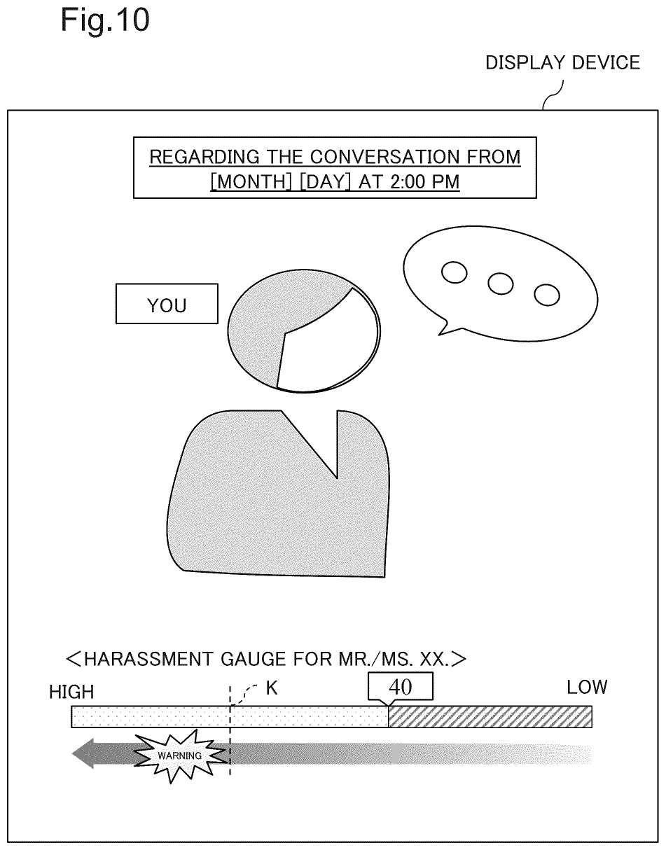

FIGS. 6 to 8 illustrate display examples on a display device that displays the harassment information. However, a display mode of the harassment information is not limited, and for example, a display mode as illustrated in FIG. 10 may be employed. In the example illustrated in FIG. 10, the harassment information is displayed for the harassment utterer. In the example of FIG. 10, a moving image (with voice) or a still image showing a state of the harassment utterer during the conversation is displayed. In addition, at the same time, the level of harassment is displayed by a harassment gauge, and in order to clarify the danger of the level of harassment, for example, a warning level K indicating a level at which a warning is required is displayed.

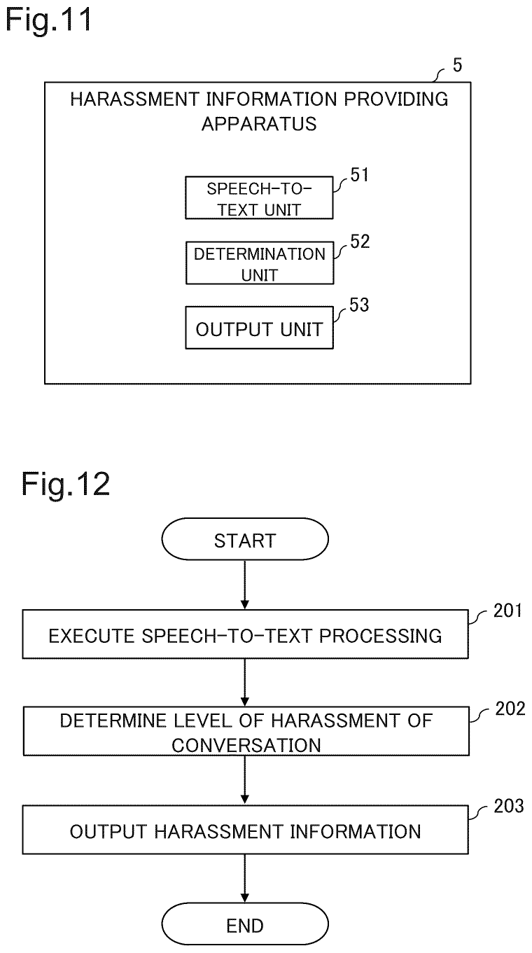

In addition, as another example embodiment, a harassment information providing apparatus can also employ a configuration as illustrated in FIG. 11. That is, a harassment information providing apparatus 5 according to another example embodiment is, for example, a computer apparatus, and includes a speech-to-text unit 51, a determination unit 52, and an output unit 53 that are functional units implemented by executing a computer program. The speech-to-text unit 51 converts an utterance of a speaker into text based on speech data of a conversation. The determination unit 52 calculates a negative level and a positive level of the conversation by analyzing text data indicating the utterance converted into text, and determines the level of harassment of the conversation by using the negative level and the positive level. The output unit 53 outputs harassment information including information indicating the level of harassment. Configuration examples of the speech-to-text unit 51, the determination unit 52, and the output unit 53 are described as the speech-to-text unit 22, the determination unit 23, and the output unit 24 in the first to third example embodiments.

Next, an example of an operation in the harassment information providing apparatus 5 will be described with reference to a flowchart in FIG. 12. For example, in a state where speech data in a conversation is acquired, the speech-to-text unit 51 converts an utterance of a speaker into text based on the speech data in the conversation (step 201). Thereafter, the determination unit 52 calculates the negative level and the positive level of the conversation by analyzing the text data indicating the utterance converted into text. Furthermore, the determination unit 52 determines the level of harassment of the conversation based on the calculated negative level and positive level (step 202). Thereafter, the output unit 53 outputs the harassment information (step 203). One of output destinations of the harassment information is, for example, a person who has made an utterance that raises a concern about harassment (harassment utterer).

Since the harassment information providing apparatus 5 determines the level of harassment in consideration of not only the negative level of the conversation but also the positive level of the conversation, it is possible to present understandable information leading to suppression of harassment to a person who has made an utterance that raises a concern about harassment in the conversation.

In other words, even in a case where there is a similar utterance that may raise a concern about harassment in the conversation, a recipient who has received the utterance may or may not feel that the recipient has been harassed. For this reason, it is difficult to accurately detect harassment in a conversation only by an utterance that may raise a concern about harassment. In addition, since there are many cases where a person who has made an utterance that may raise a concern about harassment (a harassment utterance) does not have an awareness of making a harassment utterance, it is conceivable that the person does not understand even if a notification indicating that harassment has been detected is simply made by determination on the presence or absence of harassment. For this reason, it is considered that a simple notification of harassment detection made by determination on the presence or absence of harassment may not lead to suppression of harassment.

In this regard, as described above, the harassment information providing apparatus 5 calculates the negative level and the positive level of the conversation and determines the level of harassment of the conversation using the calculated negative level and positive level. And the harassment information providing apparatus 5 outputs the harassment information. The harassment information includes information indicating the level of harassment. Therefore, the harassment information providing apparatus 5 allows the harassment utterer to notice the harassment utterance with a sense of understanding compared to the harassment utterer being notified of the fact that harassment has been detected by determination on the presence or absence of harassment.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A harassment information providing apparatus comprising:
a memory configured to store instructions; and
at least one processor configured to execute the instructions to:
convert an utterance of a speaker into text using speech data of a conversation;
calculate a negative level and a positive level of the conversation by analyzing text data indicating the utterance converted into text;
determine a level of harassment of the conversation by using the calculated negative level and positive level; and
output harassment information including information indicating the determined level of harassment.

2. The harassment information providing apparatus according to claim 1, wherein
the at least one processor is configured to execute the instructions to:
extract a negative word and a positive word from the text data of the conversation, the negative word being a negative utterance, the positive word being a positive utterance;
calculate the negative level by using a number of negative words included in the conversation;
calculate the positive level by using a number of positive words included in the conversation; and
determine the level of harassment by using the negative level and the positive level.

3. The harassment information providing apparatus according to claim 2, wherein
the at least one processor is configured to execute the instruction to calculate the negative level and the positive level by using information acquired from the speech data in addition to information regarding the number of negative words and the number of positive words included in the conversation.

4. The harassment information providing apparatus according to claim 2, wherein
the at least one processor is configured to execute the instruction to calculate the negative level and the positive level by using at least one of information indicating a relationship between speakers of the conversation and attribute information of each speaker in addition to information regarding the number of negative words and the number of positive words included in the conversation.

5. The harassment information providing apparatus according to claim 1, wherein
the at least one processor is configured to execute the instructions to:
acquire harassment resistance information indicating a degree of tolerance of each speaker to a harassment utterance that raises a concern about harassment; and
determine the level of harassment by using the harassment resistance information.

6. A harassment information providing method executed by a computer, the harassment information providing method comprising:
converting an utterance of a speaker into text using speech data of a conversation;
calculating a negative level and a positive level of the conversation by analyzing text data indicating the utterance converted into text;
determining a level of harassment of the conversation by using the calculated negative level and the positive level; and
outputting harassment information including information indicating the determined level of harassment.

7. A non-transitory computer readable medium storing a computer program for causing a computer to execute processing of:
converting an utterance of a speaker into text using speech data of a conversation;
calculating a negative level and a positive level of the conversation by analyzing text data indicating the utterance converted into text;
determining a level of harassment of the conversation by using the calculated negative level and the positive level; and
outputting harassment information including information indicating the determined level of harassment.
